(19) United States
(12) Patent Application Publication
(10) Pub. No.: US 2026/0186193 A1
(43) Pub. Date: Jul. 2, 2026

(54) BACKLIGHT MODULE AND DISPLAY PANEL

(71) Applicant: WUHAN CHINA STAR OPTOELECTRONICS TECHNOLOGY CO., LTD., Wuhan, Hubei (CN)

(72) Inventor: Ze ZHANG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/852,483

(22) PCT Filed: Jun. 29, 2023
(86) PCT No.: PCT/CN2023/104024

§ 371 Date: Sep. 29, 2024

(30) Foreign Application Priority Data
Jan. 31, 2023 (CN) 202310099667.0

(51) Int. Cl. F21V 8/00

(52) U.S. Cl. CPC G02B 6/0036; G02B 6/0076

(57) ABSTRACT

The present application provides a backlight module and a display panel. The backlight module includes a first beam splitter optical film, a second beam splitter optical film, and a third beam splitter optical film. A second beam splitter optical film is disposed between the first beam splitter optical film and the third beam splitter optical film. A structure of a microstructure lens of the second beam splitter optical film is different from a structure of a microstructure lens of the first beam splitter optical film and a structure of a microstructure lens of third beam splitter optical film, thereby easing a rainbow pattern issue resulting from the conventional light splitting film.

### FIELD OF INVENTION

The present application relates to electrical fields, especially to a backlight module and a display panel.

### BACKGROUND OF INVENTION

The Mini light emitting diode (LED) technology has great potential to become one of the development directions for the next generation of display technology. With the introduction of Mini-LED technology in mid-to-high-end tablets and laptops, the dark state display effect of low temperature poly-silicon liquid crystal display panel (LTPS-LCD) products has been greatly improved. Compared to organic light emitting diode (OLED), although Mini-LED still needs to improve in terms of thickness and response time, it has clear advantages in power consumption, HDR standards, contrast ratio (CR), brightness, and product reliability.

Due to the uniform distribution of LED lights across the lamp panel, the image quality in the backlight and module states is relatively poor, making it prone to issues such as uneven display and shadowing, which negatively affect image quality. To enhance image quality, a light splitting film is required.

However, due to the unique array microstructure of the light splitting film, a rainbow pattern tends to form between the layers of the film.

### SUMMARY OF INVENTION

An embodiment of the present application provides a backlight module and a display panel to ease a technical issue of a rainbow pattern easily formed between light splitting films due to a special array microstructure of the light splitting films.

To solve the above issue, technical solutions provided by the present application are as follows:

An embodiment of the present application provides a backlight module, the backlight module comprises:
a light emitting unit;
a first beam splitter optical film disposed on a side of the light emitting unit, wherein a plurality of first microstructure lenses are disposed a side of the first beam splitter optical film away from the light emitting unit;
a second beam splitter optical film disposed on the side of the first beam splitter optical film away from the light emitting unit, wherein a plurality of second microstructure lenses are disposed on a side of the second beam splitter optical film away from the first beam splitter optical film; and
a third beam splitter optical film disposed on the side of the second beam splitter optical film away from the first beam splitter optical film, and a plurality of third microstructure lenses are disposed on a side of the third beam splitter optical film away from the first beam splitter optical film;
wherein a structure of each of the first microstructure lens and the third microstructure lens is different from a structure of the second microstructure lens, and a shape of the first microstructure lens is the same as a shape of the third microstructure lens.

Optionally, each of a surface of the first beam splitter optical film near the light emitting unit, a surface of the second beam splitter optical film near the light emitting unit, and a surface of the third beam splitter optical film near the light emitting unit is matte.

Optionally, the shape of the first microstructure lens, a shape of the second microstructure lens, and the shape of the third microstructure lens are the same, and a size of the second microstructure lens is different from a size of the first microstructure lens and a size of the third microstructure lens.

Optionally, along a first direction from the first beam splitter optical film to the light emitting unit, a cross-section of the first microstructure lens, a cross-section of the second microstructure lens, and a cross-section of the third microstructure lens are triangular;
each of a width of the first microstructure lens and a width of the third microstructure lens is different from a width of the second microstructure lens;
each of a height of the first microstructure lens and a height of the third microstructure lens is different from the height of the second microstructure lens; and/or
a tip angle of the first microstructure lens and a tip angle of the third microstructure lens are different from a tip angle of the second microstructure lens.

Optionally, a difference between the width of the second microstructure lens and the width of the first microstructure lens is greater than or equal to a first predetermined value; and/or
a difference between the height of the second microstructure lens and the height of the first microstructure lens is greater than or equal to a second predetermined value.

Optionally, a difference between the width of the third microstructure lens and the width of the first microstructure lens is greater than or equal to a third predetermined value, the third predetermined value is less than the first predetermined value; and/or
a difference between the height of the third microstructure lens and the height of the first microstructure lens is greater than or equal to a fourth predetermined value, the fourth predetermined value is less than the second predetermined value.

Optionally, the width of the second microstructure lens is greater than the width of the first microstructure lens; and/or
the height of the second microstructure lens is greater than the height of the first microstructure lens.

Optionally, the width of the second microstructure lens is less than the width of the first microstructure lens; and/or
the height of the second microstructure lens is less than the height of the first microstructure lens.

Optionally, a density of the first microstructure lenses on the first beam splitter optical film is different from a density of the second microstructure lenses on the second beam splitter optical film.

Optionally, a distance between adjacent two of the third microstructure lenses is a first distance, a distance between adjacent two of the first microstructure lenses is a second distance, and the first distance is different from the second distance.

The embodiment of the present application also provides a display panel, comprising any one of the above backlight modules.

### Advantages

The embodiment of the present application provides a backlight module, the backlight module comprises a light emitting unit, a first beam splitter optical film, a second beam splitter optical film, and a third beam splitter optical film. The first beam splitter optical film is disposed on the light emitting unit. A plurality of first microstructure lenses are disposed on a side of the first beam splitter optical film away from the light emitting unit. The second beam splitter optical film is disposed on a side of the first beam splitter optical film away from the light emitting unit. A plurality of second microstructure lenses are disposed on a side of the second beam splitter optical film away from the first beam splitter optical film. The third beam splitter optical film is disposed on a side of the second beam splitter optical film away from the first beam splitter optical film. A plurality of third microstructure lenses are disposed on the third beam splitter optical film away from the first beam splitter optical film. A structure of the first microstructure lens and a structure of the third microstructure lens are different from a structure of the second microstructure lens. Also, a shape of the first microstructure lens is the same as a shape of the third microstructure lens. The embodiment of the present application disposes the second beam splitter optical film between the first beam splitter optical film and the third beam splitter optical film, and the structure of the microstructure lens of the second beam splitter optical film is different from structures of the microstructure lenses on the first beam splitter optical film and the third beam splitter optical film, thereby eliminating the rainbow pattern phenomenon generated between the first beam splitter optical film and the third beam splitter optical film. Furthermore, increasing the second beam splitter optical film also can increase the light splitting effect.

### DESCRIPTION OF DRAWINGS

Specific embodiments of the present invention are described in details with accompanying drawings as follows to make technical solutions and advantages of the present invention clear.

FIG. 1 is a first schematic structural view of a backlight module provided by the embodiment of the present application.

FIG. 2 is a schematic view of a size of a second beam splitter optical film in a backlight module as shown in FIG. 1.

FIG. 3 is a first schematic structural view of a first beam splitter optical film, a second beam splitter optical film, and a third beam splitter optical film in the backlight module as shown in FIG. 1.

FIG. 4 is a second schematic structural view of the first beam splitter optical film, the second beam splitter optical film, the third beam splitter optical film in the backlight module as shown in FIG. 1.

FIG. 5 is a third schematic structural view of the first beam splitter optical film, the second beam splitter optical film, and the third beam splitter optical film of the backlight module as shown in FIG. 1.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

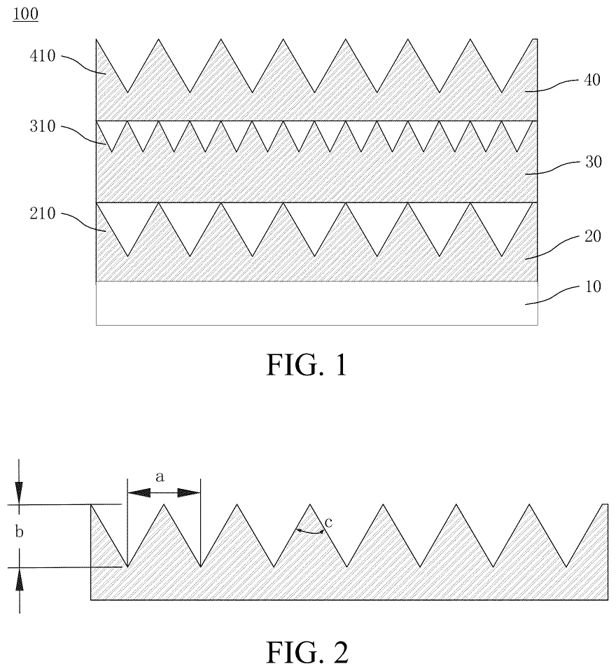

With reference to FIG. 1 and FIG. 2, FIG. 1 is a first schematic structural view of a backlight module provided by the embodiment of the present application, FIG. 2 is a schematic view of a size of a second beam splitter optical film in a backlight module as shown in FIG. 1 The embodiment of the present application provides a backlight module 100, the backlight module 100 comprises a light emitting unit 10, a first beam splitter optical film 20, a second beam splitter optical film 30, and a third beam splitter optical film 40. The first beam splitter optical film 20 is disposed on a side of the light emitting unit 10. A plurality of first microstructure lenses 210 are disposed on a side of the first beam splitter optical film 20 away from the light emitting unit 10. The second beam splitter optical film 30 is disposed on a side of the first beam splitter optical film 20 away from the light emitting unit 10. A plurality of second microstructure lenses 310 are disposed on a side of the second beam splitter optical film 30 away from the first beam splitter optical film 20. The third beam splitter optical film 40 is disposed on a side of the second beam splitter optical film 30 away from the first beam splitter optical film 20. A plurality of third microstructure lenses 410 are disposed on a side of the third beam splitter optical film 40 away from the first beam splitter optical film 20. A structure of the first microstructure lens 210 and a structure of the third microstructure lens 410 are different from a structure of the second microstructure lens 310, and a shape of the first microstructure lens 210 is the same as a shape of the third microstructure lens 410. The embodiment of the present application disposes the second beam splitter optical film 30 between the first beam splitter optical film 20 and the third beam splitter optical film 40, and a structure of a microstructure lens on the second beam splitter optical film 30 is different from a structure of microstructure lens on the first beam splitter optical film 20 and a structure of microstructure lens on the third beam splitter optical film 40, thereby eliminating rainbow pattern phenomenon between the first beam splitter optical film 20 and the third beam splitter optical film 40. Furthermore, disposing the second beam splitter optical film 30 can also can increase the light splitting effect.

As defined in the specification, “optical film” can be comprehended as a polymer film. “beam splitter optical film” can be a polymer film comprising a plurality of light splitting micro-lenses or microstructures on at least one surface. “microstructure lens” is the microstructure that a collimation light beam along an axis line, when guided to the microstructure lens, is divided into two or more light beams, and therefore have a region with a lower intensity along the axis line.

The microstructure lens can be a form of a prism and split a incident light beam into two beams, an angle between the two beams depends on the prism angle and a refractive index of prism material. In the embodiment, the microstructure lens can be a form of a quadrangular pyramid and divide an incident coaxial light beam into four light beams. In the embodiment, the microstructure lens can be a tapered form and divide an incident coaxial light beam into tapered rings. The specific form of the microstructure lens can be set according to actual conditions, and no specific limit is here.

It should be emphasized that a surface of the first beam splitter optical film 20 near the light emitting unit 10, a surface of the second beam splitter optical film 30 near the light emitting unit 10, and a surface of the third beam splitter optical film 40 near the light emitting unit 10 are matte or structures without an array.

The shape of the first microstructure lens 210 the same as the shape of the third microstructure lens 410 can be understood as the first microstructure lens 210 and the third microstructure lenses 410 having the same shape or model type, namely, they have consistent quantities of edges, and a difference between a size of the first microstructure lens 210 and a size of the third microstructure lens 410 is within a predetermined range. For example, in some embodiments, all of the structure of the first microstructure lens 210 and the structure of the third microstructure lens 410 can be inverted quadrangular pyramid or inverted triangular pyramid, and a difference between the size of the first microstructure lens 210 and the size of the third microstructure lens 410 is less than a predetermined value.

With reference to FIG. 2, the size of the first microstructure lens 210 is described according to FIG. 2. A height of the first microstructure lens 210 b is a maximum length of the first microstructure lens along a direction perpendicular to the light emitting unit 10. A width a of the first microstructure lens 210 is a projection width of the first microstructure lens 210 on the light emitting unit 10. A tip angle c of the first microstructure lens 210 is an included angle between two outermost sides as shown in the cross-sectional view. Definitions of the height, the width, and the tip angle in the following embodiments are as shown in FIG. 2, no repeated description is in the following paragraphs.

For example, in some embodiments, a difference between a width of the third microstructure lens 410 and the width of the first microstructure lens 210 is greater than or equal to a third predetermined value. For example, the third predetermined value can be 5 um, the width of the third microstructure lens 410 is 100 um, the width of the first microstructure lens 210 is 105 um, and then a difference between the width of the first microstructure lens 210 and the width of the third microstructure lens 410 is equal to the third predetermined value. A specific value of the third predetermined value, the width of the first microstructure lens 210, and the width of the third microstructure lens 410 can be set according to actual conditions, and no specific limit is here.

In some embodiments, a difference between a height of the third microstructure lens 410 and the height of the first microstructure lens 210 is greater than or equal to a fourth predetermined value. For example, the fourth predetermined value can be 5 um, the height of the third microstructure lens 410 is 50 um, the height of the first microstructure lens 210 is 45 um, and then a difference between the height of the first microstructure lens 210 and the height of the third microstructure lens 410 is equal to the fourth predetermined value. A specific value of the fourth predetermined value, the height of the first microstructure lens 210, and the height of the third microstructure lens 410 can be set according to actual conditions, and no specific limit is here.

In some other embodiments, a difference between the width of the third microstructure lens 410 and the width of the first microstructure lens 210 is greater than or equal to the third predetermined value, and a difference between the height of the third microstructure lens 410 and the height of the first microstructure lens 210 is greater than or equal to the fourth predetermined value. It should be explained that the third predetermined value and the fourth predetermined value can be the same or different, specific features can be set according to actual conditions, an no specific limit is here.

In some other embodiments, the size of the first microstructure lens 210 is the same as the size of the third microstructure lens 410.

The embodiment of the present application sets the shape of the first microstructure lens 210 the same as the shape of the third microstructure lens 410, and sets a difference between the size of the first microstructure lens 210 and the size of the third microstructure lens 410 in a predetermined range such that an original light beam from the light emitting unit 10 is split into a plurality of light beams to further spread, thereby enhancing the light splitting effect. However, when the first beam splitter optical film 20 and the third beam splitter optical film 40 are stacked together, and the pyramid direction after penetrated by the source light would generate interference phenomenon and result in rainbow pattern or diagonal stripes. Therefore, on the basis guaranteeing the light splitting effect, the second beam splitter optical film 30 is added between the first beam splitter optical film 20 and the third beam splitter optical film 40, and both the structure of the first microstructure lens 210 and the structure of the third microstructure lens 410 are different from the structure of the second microstructure lens 310, thereby counteracting the rainbow pattern phenomenon and further enhancing the light splitting effect.

It should be explained that both the structure of the first microstructure lens 210 and the structure of the third microstructure lens 410 are different from the structure of the second microstructure lens 310. It can be that the shape of the first microstructure lens 210, a shape of the second microstructure lens 310, and the shape of the third microstructure lens 410 are the same but a size of the second microstructure lens 310, the size of the first microstructure lens 210, and the size of the third microstructure lens 410 are different. It can also be that the shape of the second microstructure lens 310 is different from the shape of the first microstructure lens 210 and the shape of the third microstructure lens 410. It can also be the shape of the second microstructure lens 310 is different from the shape of the first microstructure lens 210 and the shape of the third microstructure lens 410, and the size of the second microstructure lens 310, the size of the first microstructure lens 210, and the size of the third microstructure lens 410 are different.

The condition of the shape of the second microstructure lens 310 different form the shape of the first microstructure lens 210 and the shape of the third microstructure lens 410 can be comprehended that the shape of the second microstructure lens 310 is an inverted quadrangular pyramid, and both the shape of the first microstructure lens 210 and the shape of the third microstructure lens 410 are inverted triangular pyramids. It can also be comprehended that the shape of the second microstructure lens 310 is an inverted triangular pyramid, and both the shape of the first microstructure lens 210 and the shape of the third microstructure lens 410 are inverted quadrangular pyramids. It can be comprehended that the shape of the first microstructure lens 210, the shape of the second microstructure lens 310, and the shape of the third microstructure lens 410, whether they are inverted quadrangular pyramids or inverted triangular pyramids, along a first direction from the first beam splitter optical film to the light emitting unit 10, a cross-section of the first microstructure lens 210, a cross-section of the second microstructure lenses 310, and a cross-section of the third microstructure lenses 410 are triangular. It should be emphasized that the embodiment of the present application utilizes the first microstructure lenses 210, the second microstructure lenses 310, and the structure of the third microstructure lens 410 being inverted quadrangular pyramids or inverted triangular pyramids as an example for explanation, which should not be comprehended as a limit thereto. The specific structure of the microstructure lens can be set according to actual conditions, and no specific limit is here.

The condition that the shape of the first microstructure lens 210, the shape of the second microstructure lens 310 is the same as the shape of the third microstructure lens 410, but the size of the second microstructure lens 310, the size of the first microstructure lens 210, and the size of the third microstructure lens 410 are different, can be comprehended as the following conditions. For example, in some embodiments, the first microstructure lenses 210, both the second microstructure lenses 310 and the third microstructure lenses 410 are inverted quadrangular pyramids or inverted triangular pyramids, and both the width of the first microstructure lens 210 and the width of the third microstructure lens 410 are different from a width of the second microstructure lens 310. In some embodiments, all of the first microstructure lenses 210, the second microstructure lenses 310, and the third microstructure lenses 410 are inverted quadrangular pyramids or inverted triangular pyramids. Also, both the height of the first microstructure lens 210 and the height of the third microstructure lens 410 are different from a height of the second microstructure lens 310. In some embodiments, both the first microstructure lenses 210, the second microstructure lenses 310 and the third microstructure lenses 410 are inverted quadrangular pyramids or inverted triangular pyramids, and both a tip angle of the first microstructure lenses 210 and a tip angle of the third microstructure lenses 410 are different from a tip angle of the second microstructure lenses 310. It can be understood that any two of the height, width, and tip angle of the first microstructure lens 210 are different from those of the height, width, and tip angle of the second microstructure lens 310 respectively. Also, all of the height, width, and tip angle of the first microstructure lens 210 can be different from all of the height, width, and tip angle of the second microstructure lens 310 respectively. Specific features can be set according to actual conditions, and no specific limit is here. The embodiment of the present application sets the size of the second microstructure lens 310 to be different from the size of the first microstructure lens 210 and the size of the third microstructure lens 410, thereby able to counteract the rainbow pattern phenomenon.

For example, in some embodiments, a difference between the width of the second microstructure lens 310 and the width of the first microstructure lens 210 is greater than or equal to a first predetermined value. For example, the first predetermined value can be 10 um, the width of the second microstructure lens 310 is 110 um, the width of the first microstructure lens 210 is 100 um, and a difference between then the width of the first microstructure lens 210 and the width of the second microstructure lens 310 is equal to the first predetermined value. The specific value of the third predetermined value, the width of the first microstructure lens 210, and the width of the third microstructure lens 410 can be set according to actual conditions, and no specific limit is here.

In some embodiments, a difference between the height of the second microstructure lens 310 and the height of the first microstructure lens 210 is greater than or equal to a second predetermined value. For example, the second predetermined value can be 10 um, the height of the second microstructure lens 310 is 55 um, the height of the first microstructure lens 210 is 45 um, and then a difference between the height of the first microstructure lens 210 and the height of the second microstructure lens 310 is equal to the second predetermined value. A specific value of the third predetermined value, the height of the first microstructure lens 210, and the height of the second microstructure lens 310 can be set according to actual conditions, and no specific limit is here.

In some embodiments, a difference between the width of the second microstructure lens 310 and the width of the first microstructure lens 210 is greater than or equal to the first predetermined value, and a difference between the height of the second microstructure lens 310 and the height of the first microstructure lens 210 is greater than or equal to the second predetermined value. specific features can refer to the above examples and no repeated description is here.

It should be explained that the third predetermined value is less than the first predetermined value, the fourth predetermined value is less than the second predetermined value. Such configuration can guarantee that the size of the first microstructure lens 210 is the same as the size of the third microstructure lens 410 and the size of the second microstructure lens 310 is different from the size of the first microstructure lens 210 such that the second beam splitter optical film 30 adjusts a rainbow pattern generated between the first beam splitter optical film 20 and the third beam splitter optical film 40, thereby ensuring the light splitting effect.

The condition of the size of the second microstructure lens 310 different from the size of the first microstructure lens 210 can be the size of the second microstructure lens 310 greater than the size of the first microstructure lens 210, and can also be the size of the second microstructure lens 310 smaller than the size of the first microstructure lens 210.

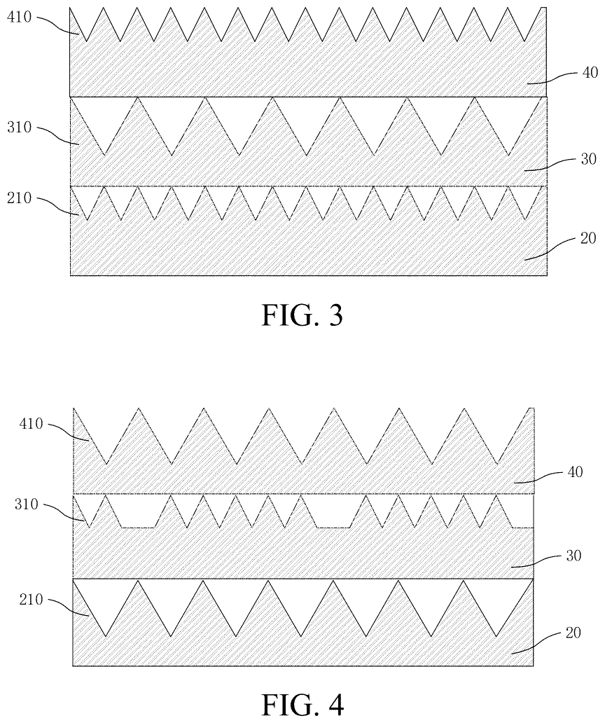

For example, with further reference to FIG. 3, FIG. 3 is a first schematic structural view of a first beam splitter optical film, a second beam splitter optical film, and a third beam splitter optical film in the backlight module as shown in FIG. 1. In some embodiments, the width of the second microstructure lens 310 is greater than the width of the first microstructure lens 210. In some embodiments, the height of the second microstructure lens 310 is greater than the height of the first microstructure lens 210. In some embodiments, the width of the second microstructure lens 310 is greater than the width of the first microstructure lens 210, and the height of the second microstructure lens 310 is greater than the height of the first microstructure lens 210.

In some embodiments, the width of the second microstructure lens 310 is less than the width of the first microstructure lens 210. In some embodiments, the height of the second microstructure lens 310 is less than the height of the first microstructure lens 210. In some embodiments, the width of the second microstructure lens 310 is less than the width of the first microstructure lens 210, and the height of the second microstructure lens 310 is less than the height of the first microstructure lens 210.

With further reference to FIG. 4, FIG. 4 is a second schematic structural view of the first beam splitter optical film, the second beam splitter optical film, the third beam splitter optical film in the backlight module as shown in FIG. 1. In some embodiments, a density of the first microstructure lenses 210 on the first beam splitter optical film 20 is different from a density of the second microstructure lenses 310 on the second beam splitter optical film 30. The condition of different densities can be the density of the first microstructure lenses 210 on the first beam splitter optical film 20 greater than the density of the second microstructure lenses 310 on the second beam splitter optical film 30, and can also be the density of the first microstructure lenses 210 on the first beam splitter optical film 20 less than the density of the second microstructure lenses 310 on the second beam splitter optical film 30, and no specific limit is here.

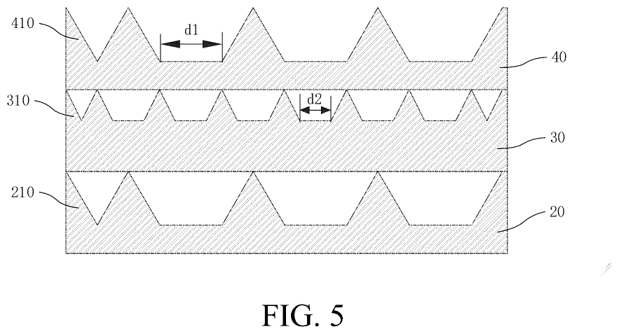

With further reference to FIG. 5, FIG. 5 is a third schematic structural view of the first beam splitter optical film, the second beam splitter optical film, and the third beam splitter optical film of the backlight module as shown in FIG. 1. In some embodiments, a distance between adjacent two of the third microstructure lenses 410 is a first distance d1, and a distance between adjacent two of the first microstructure lenses 210 is a second distance d2. The first distance d1 is different from the second distance d2. The condition of the first distance d1 different from the second distance d2 can be the first distance d1 greater than the second distance d2, and can also be the first distance d1 less than the second distance d2, and no specific limit is here.

The embodiment of the present application also provides a display panel, comprising any one of the above the backlight module 100.

In the above-mentioned embodiments, the descriptions of the various embodiments are focused. For the details of the embodiments not described, reference may be made to the related descriptions of the other embodiments.

Specific examples are used herein to explain the principles and implementations of this application. The description of the above embodiments is only intended to aid in understanding the methods and core ideas of this application. At the same time, for those skilled in the art, changes may occur in specific implementations and application scopes based on the ideas of this application. Therefore, the content of this specification should not be construed as limiting the application.

1. A backlight module, wherein the backlight module comprises:
a light emitting unit;
a first beam splitter optical film disposed on a side of the light emitting unit, wherein a plurality of first microstructure lenses are disposed a side of the first beam splitter optical film away from the light emitting unit;
a second beam splitter optical film disposed on the side of the first beam splitter optical film away from the light emitting unit, wherein a plurality of second microstructure lenses are disposed on a side of the second beam splitter optical film away from the first beam splitter optical film; and
a third beam splitter optical film disposed on the side of the second beam splitter optical film away from the first beam splitter optical film, and a plurality of third microstructure lenses are disposed on a side of the third beam splitter optical film away from the first beam splitter optical film;
wherein a structure of each of the first microstructure lens and the third microstructure lens is different from a structure of the second microstructure lens, and a shape of the first microstructure lens is the same as a shape of the third microstructure lens.

2. The backlight module according to claim 1, wherein each of a surface of the first beam splitter optical film near the light emitting unit, a surface of the second beam splitter optical film near the light emitting unit, and a surface of the third beam splitter optical film near the light emitting unit is matte.

3. The backlight module according to claim 2, wherein the shape of the first microstructure lens, a shape of the second microstructure lens, and the shape of the third microstructure lens are the same, and a size of the second microstructure lens is different from a size of the first microstructure lens and a size of the third microstructure lens.

4. The backlight module according to claim 3, wherein along a first direction from the first beam splitter optical film to the light emitting unit, a cross-section of the first microstructure lens, a cross-section of the second microstructure lens, and a cross-section of the third microstructure lens are triangular;
each of a width of the first microstructure lens and a width of the third microstructure lens is different from a width of the second microstructure lens;
each of a height of the first microstructure lens and a height of the third microstructure lens is different from the height of the second microstructure lens; and/or
a tip angle of the first microstructure lens and a tip angle of the third microstructure lens are different from a tip angle of the second microstructure lens.

5. The backlight module according to claim 4, wherein a difference between the width of the second microstructure lens and the width of the first microstructure lens is greater than or equal to a first predetermined value; and/or
a difference between the height of the second microstructure lens and the height of the first microstructure lens is greater than or equal to a second predetermined value.

6. The backlight module according to claim 5, wherein a difference between the width of the third microstructure lens and the width of the first microstructure lens is greater than or equal to a third predetermined value, the third predetermined value is less than the first predetermined value; and/or
a difference between the height of the third microstructure lens and the height of the first microstructure lens is greater than or equal to a fourth predetermined value, the fourth predetermined value is less than the second predetermined value.

7. The backlight module according to claim 6, wherein the width of the second microstructure lens is greater than the width of the first microstructure lens; and/or
the height of the second microstructure lens is greater than the height of the first microstructure lens.

8. The backlight module according to claim 6, wherein the width of the second microstructure lens is less than the width of the first microstructure lens; and/or
the height of the second microstructure lens is less than the height of the first microstructure lens.

9. The backlight module according to claim 1, wherein a density of the first microstructure lenses on the first beam splitter optical film is different from a density of the second microstructure lenses on the second beam splitter optical film.

10. The backlight module according to claim 1, wherein a distance between adjacent two of the third microstructure lenses is a first distance, a distance between adjacent two of the first microstructure lenses is a second distance, and the first distance is different from the second distance.

11. A display panel, wherein the display panel comprises a backlight module, and the backlight module comprises:
a light emitting unit;
a first beam splitter optical film disposed on a side of the light emitting unit, wherein a plurality of first microstructure lenses are disposed a side of the first beam splitter optical film away from the light emitting unit;
a second beam splitter optical film disposed on the side of the first beam splitter optical film away from the light emitting unit, wherein a plurality of second microstructure lenses are disposed on a side of the second beam splitter optical film away from the first beam splitter optical film; and
a third beam splitter optical film disposed on the side of the second beam splitter optical film away from the first beam splitter optical film, and a plurality of third microstructure lenses are disposed on a side of the third beam splitter optical film away from the first beam splitter optical film;
wherein a structure of each of the first microstructure lens and the third microstructure lens is different from a structure of the second microstructure lens, and a shape of the first microstructure lens is the same as a shape of the third microstructure lens.

12. The display panel according to claim 11, wherein each of a surface of the first beam splitter optical film near the light emitting unit, a surface of the second beam splitter optical film near the light emitting unit, and a surface of the third beam splitter optical film near the light emitting unit is matte.

13. The display panel according to claim 12, wherein the shape of the first microstructure lens, a shape of the second microstructure lens, and the shape of the third microstructure lens are the same, and a size of the second microstructure lens is different from a size of the first microstructure lens and a size of the third microstructure lens.

14. The display panel according to claim 13, wherein along a first direction from the first beam splitter optical film to the light emitting unit, a cross-section of the first microstructure lens, a cross-section of the second microstructure lens, and a cross-section of the third microstructure lens are triangular;
each of a width of the first microstructure lens and a width of the third microstructure lens is different from a width of the second microstructure lens;
each of a height of the first microstructure lens and a height of the third microstructure lens is different from the height of the second microstructure lens; and/or
a tip angle of the first microstructure lens and a tip angle of the third microstructure lens are different from a tip angle of the second microstructure lens.

15. The display panel according to claim 14, wherein a difference between the width of the second microstructure lens and the width of the first microstructure lens is greater than or equal to a first predetermined value; and/or
a difference between the height of the second microstructure lens and the height of the first microstructure lens is greater than or equal to a second predetermined value.

16. The display panel according to claim 15, wherein a difference between the width of the third microstructure lens and the width of the first microstructure lens is greater than or equal to a third predetermined value, the third predetermined value is less than the first predetermined value; and/or
a difference between the height of the third microstructure lens and the height of the first microstructure lens is greater than or equal to a fourth predetermined value, the fourth predetermined value is less than the second predetermined value.

17. The display panel according to claim 16, wherein the width of the second microstructure lens is greater than the width of the first microstructure lens; and/or
the height of the second microstructure lens is greater than the height of the first microstructure lens.

18. The display panel according to claim 16, wherein the width of the second microstructure lens is less than the width of the first microstructure lens; and/or
the height of the second microstructure lens is less than the height of the first microstructure lens.

19. The display panel according to claim 11, wherein a density of the first microstructure lenses on the first beam splitter optical film is different from a density of the second microstructure lenses on the second beam splitter optical film.

20. The display panel according to claim 11, wherein a distance between adjacent two of the third microstructure lenses is a first distance, a distance between adjacent two of the first microstructure lenses is a second distance, and the first distance is different from the second distance.
